(19) United States
(12) Patent Application Publication
(10) Pub. No.: US 2008/0019804 A1
(43) Pub. Date: Jan. 24, 2008

(54) Container Opening-Closing Apparatus and Container-Placement-Position Adjustment Method for the Same

(75) Inventor: Noriyoshi Toyoda, Tokyo (JP)

Correspondence Address: BACON & THOMAS, PLLC, 625 SLATERS LANE, FOURTH FLOOR, ALEXANDRIA, VA, 22314, US

(73) Assignee: Hirata Corporation, Tokyo (JP)

(21) Appl. No.: 11/629,388

(22) PCT Filed: Jun. 14, 2004
(86) PCT No.: PCT/JP04/08670

§ 371 Date: Dec. 13, 2006

(51) Int. Cl. B65G 49/07

(52) U.S. Cl. 414/8; 414/787; 414/801

(57) ABSTRACT

A container opening-closing apparatus 1 includes at least a dock plate 31 for supporting and positioning a container 10 capable of accommodating a plurality of semiconductor wafers 14; a dock-moving mechanism 30 for moving the dock plate 31 between a container transfer position and a work position where a container door 13 is attached and detached; a port door 23 including an attaching-detaching mechanism for attaching and detaching the container door 13 and a holding mechanism for holding the container door 13; a port-door advancing-retracting mechanism for horizontally moving the port door 23; a port-door elevating mechanism for vertically moving the port door 23 with the container door 13 held thereby so as to store the container door 13; and a port plate 21 having an opening closed by the port door 23, wherein the dock-moving mechanism 30 includes stop position changing means for changing the stop position of the dock plate 31 to a desired position.

### TECHNICAL FIELD

The present invention relates to a container opening-closing apparatus for opening and closing a sealable container for containing and carrying a plurality of semiconductor wafers oriented horizontally and arranged in layers at predetermined intervals, and to a container-placement-position adjustment method for the same. More particularly, the invention relates to a mechanism and method which enable the placement position of the container to be changed to a desired position at a placement section where the container is transferred.

### BACKGROUND ART

Recently, more and more facilities have come to use a localized clean room, which is called a mini-environment, for the purpose of lowering investment in a large-scale clean room and process automation. In a mini-environment process, a facility maintained in a highly clean condition is provided locally, and handling of wafers is performed within the facility. For conveyance of wafers, a sealed-type wafer carrier (FOUP: Front Opening Unified Pod) is utilized so as to protect wafers from particles.

A wafer carrier used in the mini-environment is equipped with a lock mechanism so that the carrier does not open easily during conveyance, and a dedicated container opening-closing apparatus, a so-called FOUP opener, is required so as to automatically open and close the wafer carrier. The wafer carrier is conveyed to a position above a placement section of a FOUP opener from another process by means of a conveying apparatus such as an overhead traveling conveying apparatus or a transfer apparatus, and transferred to the placement section.

Such a FOUP opener is typically provided at ports through which wafers are conveyed into or conveyed out of a process apparatus, and its dimensions are specified by SEMI (Semiconductor Equipment Materials International). Similarly, the dimensions of wafer carriers are specified by SEMI. Thus, positioning pins provided at the placement section of the FOUP opener coincide with positioning grooves of a wafer carrier, whereby the wafer carrier is placed at the placement position of the FOUP opener without fail. Therefore, the positioning grooves of the wafer carrier are in the form of a groove hole of a minimum size, which is machined in a conical shape for facilitating the positioning. By virtue of this configuration, a wafer carrier conveyed by means of the overhead traveling conveying apparatus or a transfer apparatus is accurately transferred between the placement section of the FOUP opener and the conveying apparatus.

Meanwhile, a conveying apparatus, such as an overhead traveling conveying apparatus or a transfer apparatus, has some degree of variation in its stop position. Therefore, for transfer of a wafer carrier between the placement section of the FOUP opener and the transfer apparatus, alignment along X-axis and Y-axis directions is required. Although the position along the X-axis direction (traveling direction) of the overhead traveling conveying apparatus or the transfer apparatus can be adjusted relatively easily through correction of the stop position, adjustment of the position along the Y-axis direction requires adjustment of the traveling track, adjustment of the placement position of the FOUP opener, or adjustment of the position of the entire process apparatus in which the FOUP opener is provided.

In order to overcome the above-described drawback, an arm-type mechanism is provided at a wafer carrier holding section of a transfer apparatus so as to move a wafer carrier in an arbitrary direction and place it on the placement section of a FOUP opener (see Japanese Patent Application Laid-Open (kokai) No. 2003-051527).

### DISCLOSURE OF THE INVENTION

However, in the case where an arm-type mechanism is provided at the carrier holding section so as to transfer a wafer carrier between the placement section of a FOUP opener and a transfer apparatus, it becomes necessary to secure a space for enabling swing motion of the arm. Further, due to an increased distance between the transfer apparatus support portion and the wafer carrier holding portion, a wafer carrier vibrates at the time of positioning in a horizontal motion of the transfer apparatus. In such a case, the wafer carrier must be held at that position until the generated vibration stops, thereby lengthening the transfer time of the wafer carrier. Further, when an additional mechanism such as an arm-type mechanism is provided on the transfer apparatus, the transfer apparatus becomes complex and large, leading to increased cost.

An object of the present invention is to solve the above-mentioned problems in the conventional container opening-closing apparatus (FOUP opener) and its container-placement-position adjustment method, and to provide a container opening-closing apparatus and a container-placement-position adjustment method therefor, which adjust a misalignment between the position of a dock plate provided on the container opening-closing apparatus and a positioning groove provided on a container for alignment with the dock plate, to thereby enable smooth alignment between the container placement position of the dock plate and the positioning groove of the container.

According to the present invention, the above-described problems are solved by a container opening-closing apparatus and a container-placement-position adjustment method therefor as described below.

That is, a container opening-closing apparatus of the present invention comprises at least a dock plate for supporting and positioning a container capable of accommodating a plurality of semiconductor wafers oriented horizontally and arranged at predetermined intervals; a dock-moving mechanism for moving the dock plate between a container transfer position and a work position where a container door is attached and detached; a port door including an attaching-detaching mechanism for attaching and detaching the container door and a holding mechanism for holding the container door; a port-door advancing-retracting mechanism for horizontally moving the port door; a port-door elevating mechanism for vertically moving the port door with the container door held thereby so as to store the container door; and a port plate having an opening closed by the port door, wherein the dock-moving mechanism includes stop position changing means for changing the stop position of the dock plate to a desired position.

In a preferred embodiment, the stop position changing means includes control means for changing the stop position of the dock plate to a desired position by means of numerical control.

In another preferred embodiment, when a moving direction along which the dock plate moves for removal of the container door is defined as an X-axis direction and a direction perpendicular to the X-axis direction is defined as a Y-axis direction, the stop position of the dock plate can be changed to a desired position in the X-axis direction.

In still another preferred embodiment, when a moving direction along which the dock plate moves for removal of the container door is defined as an X-axis direction and a direction perpendicular to the X-axis direction is defined as a Y-axis direction, the stop position of the dock plate can be changed to desired positions in the X-axis and Y-axis directions.

As described above, the dock-moving mechanism includes stop position changing means for changing the stop position of the dock plate of the container opening-closing apparatus to a desired position. Therefore, when a container is transferred between a conveying apparatus and a container placement section (provided on the dock plate) of the container opening-closing apparatus, the container placement position can be flexibly set to a desired position, so that different containers and a deviation between the container placement section of the container opening-closing apparatus and the conveying apparatus can be easily and individually coped with. In addition, when this is performed by means of numerical control, accurate transfer of a container can be performed automatically, and a special mechanism for checking the stop position is not required.

Another container opening-closing apparatus of the present invention comprises at least a dock plate for supporting and positioning a container capable of accommodating a plurality of semiconductor wafers oriented horizontally and arranged at predetermined intervals; a dock-moving mechanism for moving the dock plate between a container transfer position and a work position where a container door is attached and detached; a port door including an attaching-detaching mechanism for attaching and detaching the container door and a holding mechanism for holding the container door; a port-door advancing-retracting mechanism for horizontally moving the port door; a port-door elevating mechanism for vertically moving the port door with the container door held thereby so as to store the container door; and a port plate having an opening closed by the port door, wherein the dock-moving mechanism includes stop position checking means for checking a stop position of the dock plate, and installation position changing means for changing the installation position of the stop position checking means to a desired position.

In a preferred embodiment, the installation position changing means includes control means for changing the installation position of the stop position checking means to a desired position by means of numerical control.

In another preferred embodiment, when a moving direction along which the dock plate moves for removal of the container door is defined as an X-axis direction and a direction perpendicular to the X-axis direction is defined as a Y-axis direction, the installation position of the stop position checking means can be changed to a desired position in the X-axis direction.

In still another preferred embodiment, when a moving direction along which the dock plate moves for removal of the container door is defined as an X-axis direction and a direction perpendicular to the X-axis direction is defined as a Y-axis direction, the installation position of the stop position checking means can be changed to desired positions in the X-axis and Y-axis directions.

As described above, the dock-moving mechanism includes stop position checking means for checking a stop position of the dock plate of the container opening-closing apparatus, and further includes installation position changing means for changing the installation position of the stop position checking means to a desired position. Therefore, when a container is transferred between a conveying apparatus and a container placement section (provided on the dock plate) of the container opening-closing apparatus, it is possible to accurately check the stop position of the dock plate without fail, and flexibly set the container placement position on the dock plate to a desired position, so that different containers and a deviation between the container placement section of the container opening-closing apparatus and the conveying apparatus can be easily and individually coped with. In addition, when this is performed by means of numerical control, transfer of a container can be performed automatically in a more accurate manner.

A container-placement-position adjustment method according to the present invention is used for a container opening-closing apparatus which includes at least container placement means for supporting and positioning a container capable of accommodating a plurality of semiconductor wafers oriented horizontally and arranged at predetermined intervals; moving means for moving the container placement means between a container transfer position and a work position where a container door is attached and detached; and attaching-detecting means for attaching and detaching the container door of the container placed on the container placement means moved to the work position by the moving means, wherein the moving means can change a stop position of the container placement means to a desired position.

In a preferred embodiment, the moving means changes the stop position of the container placement means to a desired position by means of numerical control.

In the above-described container-placement-position adjustment method, the moving means can change a stop position of the container placement means to a desired position. Therefore, when a container is transferred between a conveying apparatus and a container placement section (provided on the container placement means) of the container opening-closing apparatus, it is possible to easily and flexibly position the container placement section to a desired position, so that different containers and a deviation between the container placement section of the container opening-closing apparatus and the conveying apparatus can be easily and individually coped with. In addition, when this is performed by means of numerical control, accurate transfer of a container can be performed automatically, and a special mechanism for checking the stop position is not required.

A container-placement-position adjustment method according to the present invention is used for a container opening-closing apparatus which includes at least container placement means for supporting and positioning a container capable of accommodating a plurality of semiconductor wafers oriented horizontally and arranged at predetermined intervals; moving means for moving the container placement means between a container transfer position and a work position where a container door is attached and detached; and attaching-detecting means for attaching and detaching the container door of the container placed on the container placement means moved to the work position by the moving means, wherein the moving means can change to a desired position a position for checking a stop position of the container placement means.

In a preferred embodiment, the moving means changes the position for checking the stop position of the container placement means by means of numerical control.

In the above-described container-placement-position adjustment method, the moving means can change the position for checking the stop position of the container placement means to a desired position. Therefore, when a container is transferred between a conveying apparatus and a container placement section (provided on the container placement means) of the container opening-closing apparatus, the moving means can accurately check the stop position of the container placement means, on the basis of which the container placement section of the container opening-closing apparatus can be easily and flexibly positioned to a desired position, so that different containers and a deviation between the container placement section of the container opening-closing apparatus and the conveying apparatus can be easily, accurately, and individually coped with. In addition, when this is performed by means of numerical control, transfer of a container can be performed automatically in a more accurate manner.

According to the configuration of the container opening-closing apparatus and the container-placement-position adjustment method of the present invention, a large number of types of containers and errors between a conveying apparatus and the container placement section of the container opening-closing apparatus can be coped with without a kind of large scaled apparatuses, whereby accurate transfer of containers between the conveying apparatus and the container opening-closing apparatus becomes possible.

### BRIEF DESCRIPTION OF THE DRAWINGS

FIG. 1 is a schematic view of a FOUP opener corresponding to a container opening-closing apparatus of a first embodiment (Embodiment 1) of the present invention.

FIG. 2 is a set of schematic views of the FOUP opener, wherein (a) is a vertical sectional view, (b) is a partial front view, and (c) is a plan view.

FIG. 3 is a set of schematic views of a FOUP opener according to a second embodiment (Embodiment 2) of the present invention, wherein (a) is a vertical sectional view, (b) is a partial front view, and (c) is a plan view.

FIG. 4 is a set of schematic views showing dock-position adjustment mechanism (dock-moving mechanism) according to Embodiment 1 and its modification.

FIG. 5 is a set of schematic views showing dock-position adjustment mechanism (dock-moving mechanism) according to Embodiment 2 and its modification.

FIG. 6 is a set of operational views relating to Embodiment 1 and showing a basic condition in which the door of a FOUP advanced to a work position is in contact with an engagement surface of a port door.

FIG. 7 is a pair of operational views relating to Embodiment 1 and showing alignment between the dock plate and the FOUP.

FIG. 8 is a set of operational views relating to Embodiment 2 and showing alignment between the dock plate and the FOUP.

FIG. 9 is a pair of schematic diagrams showing a control configuration of the FOUP opener in Embodiment 1.

FIG. 10 is a pair of schematic diagrams showing a control configuration of the FOUP opener in Embodiment 2.

FIG. 11 is a general flowchart showing an operation for attaining alignment between the dock plate and a FOUP conveying apparatus in a conventional technique.

FIG. 12 is a general flowchart showing an operation for attaining alignment between the dock plate and a FOUP conveying apparatus in Embodiments 1 and 2.

FIG. 13 is a set of schematic views showing other embodiments of a detection-sensor moving mechanism in Embodiment 2 and its modification.

FIG. 14 is a set of schematic views showing other embodiments of the dock-moving mechanism in Embodiment 1 and its modification.

### BEST MODE FOR CARRYING OUT THE INVENTION

A container opening-closing apparatus according to the present invention includes at least a dock plate for supporting and positioning a container capable of accommodating a plurality of semiconductor wafers oriented horizontally and arranged at predetermined intervals; a dock-moving mechanism for moving the dock plate between a container transfer position and a work position where a container door is attached and detached; a port door including an attaching-detaching mechanism for attaching and detaching the container door, and a holding mechanism for holding the container door; a port-door advancing-retracting mechanism for horizontally moving the port door; a port-door elevating mechanism for vertically moving the port door with the container door held thereby so as to store the container door; and a port plate having an opening closed by the port door, wherein the dock-moving mechanism includes stop position changing means for changing the stop position of the dock plate to a desired position.

Preferably, the stop position changing means includes control means for changing the stop position of the dock plate to a desired position by means of numerical control. Preferably, when a moving direction along which the dock plate moves for removal of the container door is defined as an X-axis direction and a direction perpendicular to the X-axis direction is defined as a Y-axis direction, the stop position of the dock plate can be changed to a desired position at least in the X-axis direction. Preferably, stop-position checking means is provided so as to check and detect the stop position of the dock plate.

### EMBODIMENT 1

Next, a first embodiment (Embodiment 1) of the present invention will be described in detail with reference to the drawings.

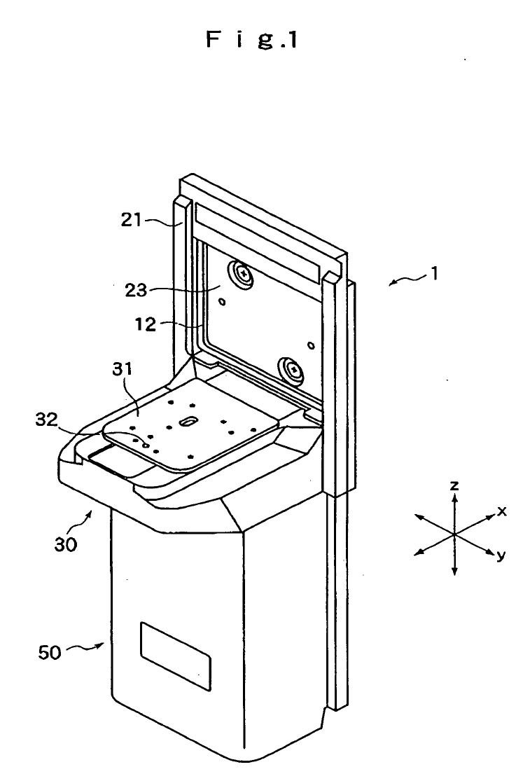

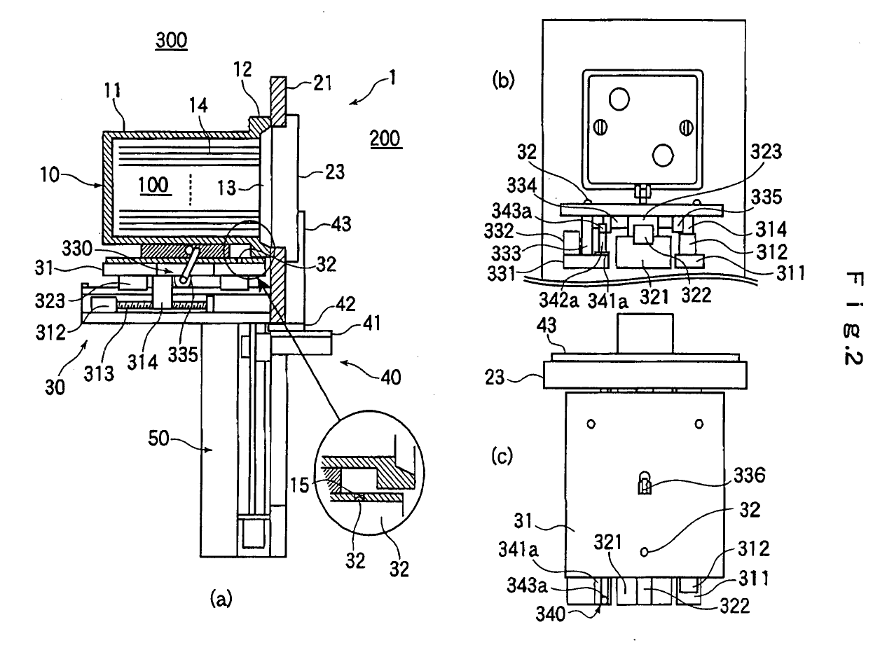

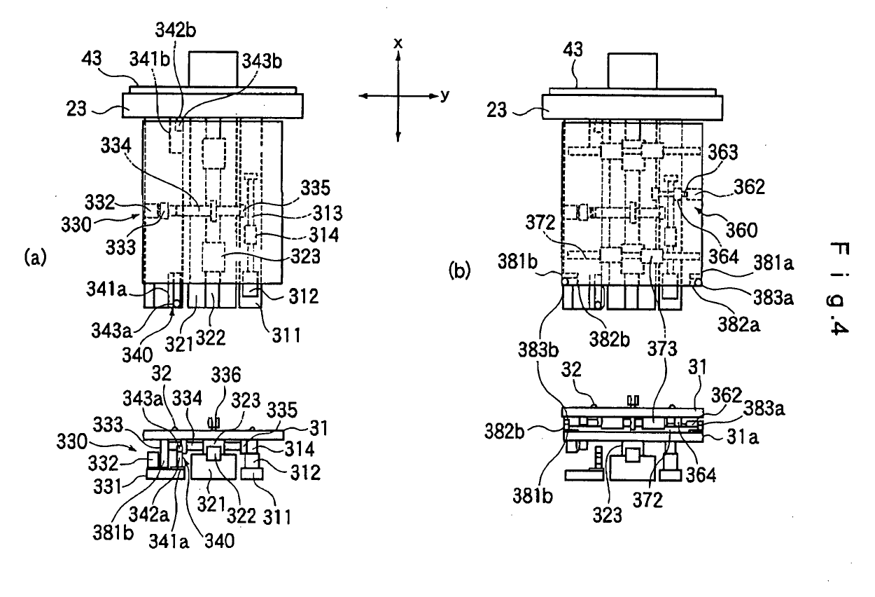

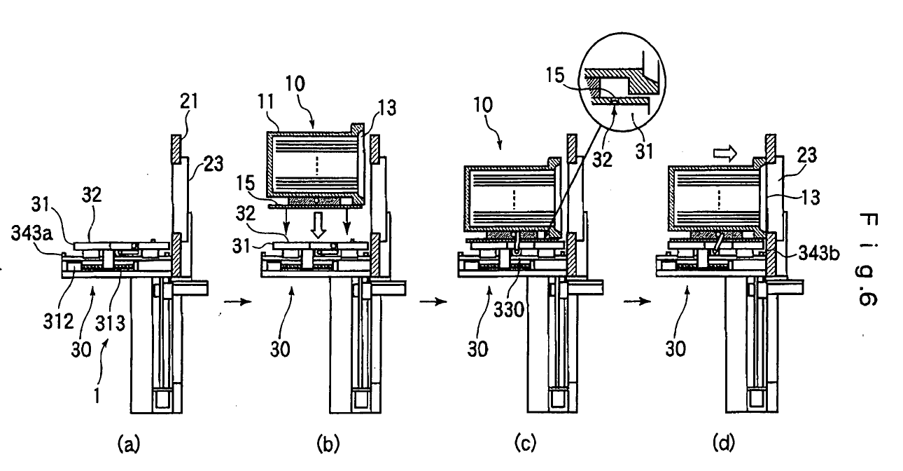

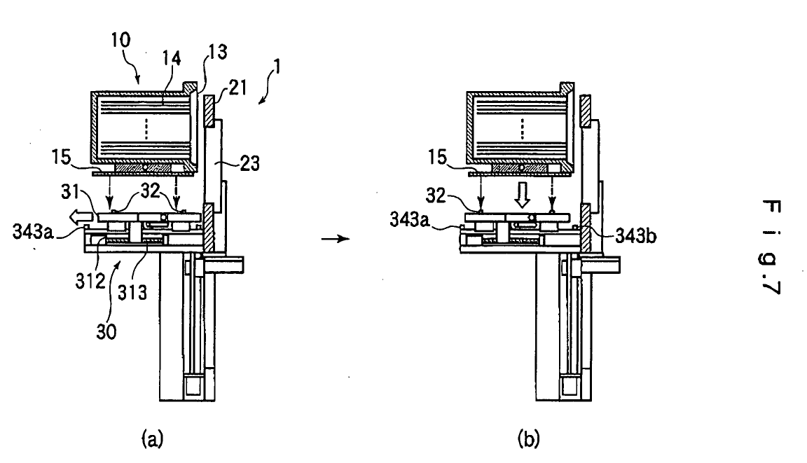

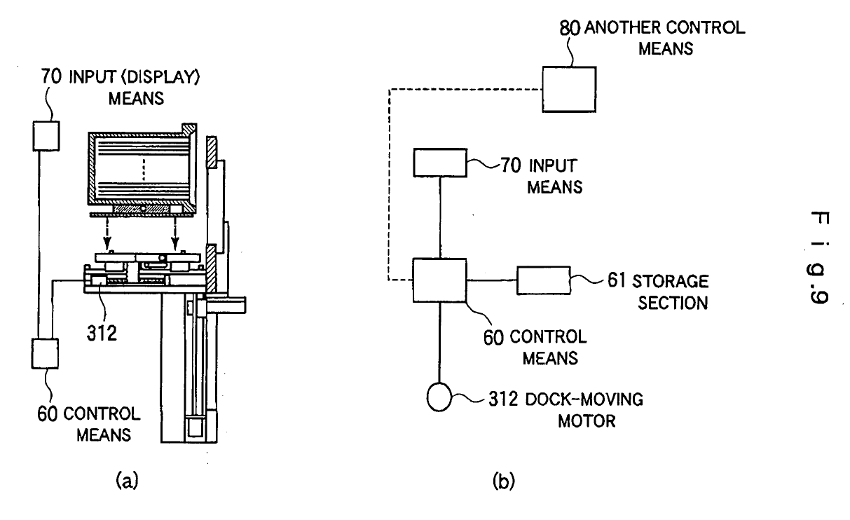

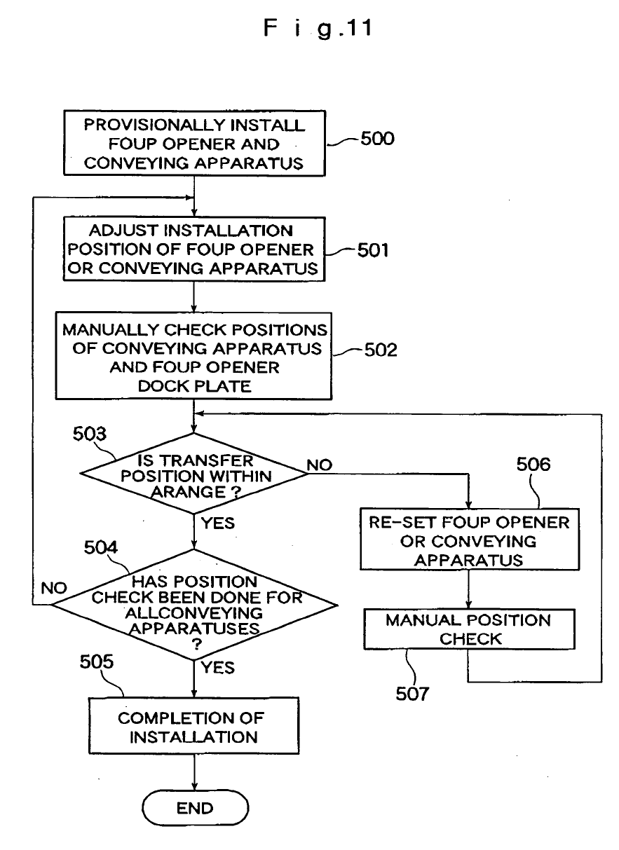

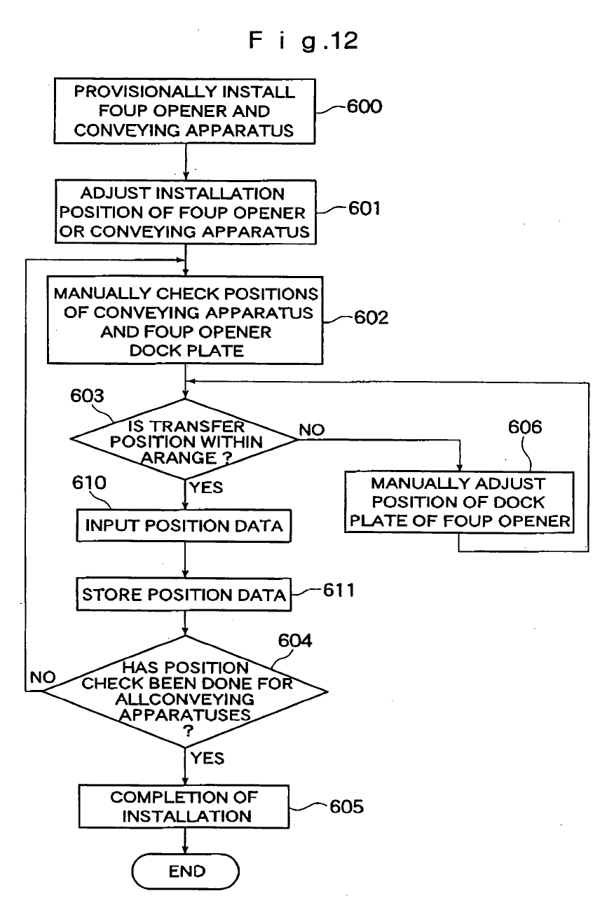

FIG. 1 is a schematic view of a FOUP opener corresponding to a container opening-closing apparatus of Embodiment 1 of the present invention; FIG. 2 is a set of schematic views of the FOUP opener, wherein (a) is a vertical sectional view, (b) is a partial front view, and (c) is a plan view; FIG. 4 is a set of schematic views showing dock-position adjustment mechanism (dock-moving mechanism) according to Embodiment 1 and its modification; FIG. 6 is a set of operational views relating to Embodiment 1 and showing a condition in which the door of a FOUP advanced to a work position is in contact with. an engagement surface of a port door; FIG. 7 is a pair of operational views relating to Embodiment 1 and showing alignment between the dock plate and the FOUP; FIG. 9 is a pair of schematic diagrams showing a control configuration of the FOUP opener in Embodiment 1; FIG. 11 is a general flowchart showing an operation for attaining alignment between the dock plate and a conveying apparatus in a conventional technique; and FIG. 12 is a general flowchart showing an operation for attaining alignment between the dock plate and a conveying apparatus in Embodiment 1.

In FIGS. 1 and 2, for transfer of wafers 14 within a FOUP 10, a FOUP opener 1 opens a FOUP door 13 without exposing the wafers 14 to the atmosphere of an external contaminated space 300 to thereby establish communication between a first control space 100 in the FOUP and a second control space 200. Therefore, the FOUP 10 must be placed at a predetermined position of the FOUP opener 1 without fail. In Embodiment 1, this requirement is satisfied as described below.

As shown in FIG. 2 and FIG. 4(a), the FOUP opener 1 in Embodiment 1 includes at least the FOUP 10 which accommodates a plurality of semiconductor wafers 14 oriented horizontally and arranged at predetermined intervals; a dock plate 31 for supporting and positioning the FOUP 10; a dock-moving mechanism 30 for moving the dock plate 31 between a FOUP transfer position and a work position where the FOUP door 13 is attached and detached; a port door 23 including an attaching-detaching mechanism for attaching and detaching the FOUP door 13, and a holding mechanism for holding the FOUP door 13; a port-door advancing-retracting mechanism 40 for horizontally moving the port door 23; a port-door elevating mechanism 50 for vertically moving the port door 23 with the FOUP door 13 held thereby so as to store the FOUP door 13; and a port plate 21 having an opening closed by the port door 23.

The FOUP 10 is composed of a FOUP frame 11 and the FOUP door 13, which serves as a lid for opening and closing a front opening 12 of the FOUP frame 11.

Positioning pins 32 are fixedly attached to the dock plate 31 at intervals generally equal to those of positioning grooves 15 formed in the FOUP 10. The positioning pins 32 are slightly smaller in size than the positioning grooves 15 so. as to facilitate establishment of alignment with the positioning grooves 15. The dock-moving mechanism 30 includes a base 321, a rail 322, two slide members 323, a base 311, a dock-moving motor 312, a ball screw 313, a transmission member 314, and a lock mechanism 330. The base 321 is disposed below the dock plate 31. The rail 322 is fixedly mounted to the upper surface of the base 321 and has a mating groove formed thereon. The two slide members 323 are slidably fitted in the mating groove of the rail 322 with a predetermined interval formed therebetween. The base 311 is disposed below the dock plate 31. The dock-moving motor 312 is disposed on the base 311 and serves as a drive source for moving the dock plate 31. The ball screw 313 is mounted and supported on the base 311 to be rotatable together with the output shaft of the dock-moving motor 312 and has a thread groove formed thereon. The transmission member 314 is in screw engagement with the thread groove of the ball screw 313 and moves horizontally upon rotation of the ball screw 313. The lock mechanism 330 is provided on the lower surface of the dock plate 31 and provides a lock function. That is, when the dock plate 31 moves, the lock mechanism 330 moves together with the dock plate 31, so as to temporarily fix the FOUP 10 on the dock plate 31 to thereby prevent the placed FOUP 10 from falling off the dock plate 31.

The lock mechanism 330 includes a lock motor 332 outputting a rotational power; a transmission mechanism 333 fixedly mounted to the lower surface of the dock plate 31 and connected to the output shaft of the lock motor 332 so as to transmit the rotational power; a support member 335 fixedly mounted to the lower surface of the dock plate 31 and including a bearing; a transmission member 334 rotatably supported by the bearing of the support member 335 and having one end connected to the transmission mechanism 333; and a lock head 336 fixedly mounted to a portion of the transmission member 334 and adapted to move when the transmission member 334 rotates.

Further, the dock-moving mechanism 30 includes a detection-checking mechanism 340 provided below the dock plate 31 and adapted to detect the dock plate 31. The detection-checking mechanism 340 includes detection sensors 343a and 343b, which are fixedly mounted to mounting members 342a and 342b, respectively. The mounting members 342a and 342b are fixedly mounted to fixing members 341a and 341b, respectively, which are fixedly mounted to an upper portion of the base 331 disposed below the dock plate 31.

Modification of Embodiment 1

Next, a modification of Embodiment 1 will be described in detail with reference to FIGS. 4(a) and 4(b).

FIGS. 4(a) and 4(b) differ in the structure of the dock-moving mechanism. The dock-moving mechanism 30 shown in FIG. 4(b) is configured to move the dock plate 31 in two directions; i.e., the X-axis and Y-axis directions. This structure differs from that shown in FIG. 4(a). Since the remaining components and mechanisms are the same as those shown in FIG. 4(a), they are denoted by the same names and reference numerals, and their detailed description will not be repeated.

In the dock-moving mechanism 30 shown in FIG. 4(a), the dock plate 31 is mounted to a mounting surface of the slide member 323. In contrast, in the dock-moving mechanism 30 shown in FIG. 4(b), in place of the dock plate 31, an auxiliary plate 31a is mounted to the mounting surface of the slide member 323 so as to move the dock plate 31 in two directions; i.e., the X-axis and Y-axis directions. Two generally parallel rails 372 are fixedly mounted on the upper surface of the auxiliary plate 31a at a predetermined interval such that the rails 372 extend generally parallel to the plane of the port door 23. Two slide members 373 are attached to each rail 372 to be slidable along the rail 372. The dock plate 31 is fixedly mounted to the upper surfaces of the slide members 373.

A dock plate moving mechanism 360 is provided between the two rails 372 so as to move the dock plate 31 in the Y-axis direction. The dock plate moving mechanism 360 includes a dock-moving motor 362 serving as a drive source; a ball screw 363 for transmitting rotational torque output from the output shaft of the dock-moving motor 362; and a transmission member 364 which is in screw engagement with the thread groove of the ball screw 363 and slides horizontally upon rotation of the ball screw 363. The transmission member 364 is fixedly mounted to a portion of the lower surface of the dock plate 31. This structure enables the dock plate 31 to move in the Y-axis direction.

Further, detection sensors 383a and 383b are attached to mounting members 382a and 382b, respectively, so as to detect and restrict the movement of the dock plate 31 in the Y-axis direction. The mounting members 382a and 382b are attached to fixing members 381a and 381b, respectively, which are attached to end portions of the upper surface of the auxiliary plate 31a. The detection sensors 383a and 383b are fixedly mounted at respective positions (two positions) corresponding to the opposite moving ends of the dock plate 31 so as to enable the detection sensors 383a and 383b to detect the dock plate 31 moving in the Y-axis direction. These sensors constitute a detection-checking mechanism for detecting the dock plate 31 moving in the Y-axis direction.

FOUP-Receiving Operation of Embodiment 1

Next, operation steps in Embodiment 1, from receiving the FOUP 10 to moving the FOUP 10 to a work position, will be described with reference to FIGS. 6(a) to 6(d).

When the FOUP 10 is not placed on the dock plate 31, the dock plate 31 stands by at the FOUP transfer position (position apart from the port plate 21). At this time, the detection sensors 343a and 343b are used as a means for checking the dock plate 31 so as to define the limit of movement of the dock plate 31 and check its stop position (FIG. 6(a)).

Next, the FOUP 10 is conveyed onto the FOUP opener 1 by means of an unillustrated conveying apparatus, and the conveying apparatus stops generally above the dock plate 31. After stoppage, signal communication is performed between the conveying apparatus and the FOUP opener 1, and the FOUP 10 is transferred onto the dock plate 31 such that the positioning grooves 15 of the FOUP 10 are aligned with the positioning pins 32 provided on the dock plate 31 (FIG. 6(b)).

The FOUP 10 placed on the dock plate 31 is temporarily fixed on the dock plate 31 by means of lock action of the lock mechanism 330 (FIG. 6(c)).

After the FOUP 10 is locked on the dock plate 31, the FOUP 10 is moved to a work position (position close to the port plate 21) through operation of the dock-moving mechanism 30 (FIG. 6(d)).

When the FOUP 10 reaches the work position, the FOUP door 13 is unlocked by means of a FOUP-door opening-closing mechanism incorporated in the port door 23, and is removed from the FOUP frame 11. After that, the FOUP door 13 is held on the port door 23, which is then horizontally moved to a predetermined position by the port-door advancing-retracting mechanism 40, and is lowered to a predetermined position by the port-door elevating mechanism 50.

The above is the general operation during a period in which the FOUP 10 is conveyed by an unillustrated conveying apparatus and is received by the FOUP opener 1, and the FOUP door 13 is removed. Notably, the operation from attachment of the FOUP door 13 to transfer of the FOUP 10 to the conveying apparatus is performed in an order that is reverse that of the receiving operation.

Alignment Operation of Embodiment 1

Next, operation of establishing alignment between the positioning grooves 15 of the FOUP 10 and the positioning pins 32 of the dock plate 31 in Embodiment 1 will be described with reference to FIGS. 7 and 9.

When the FOUP 10 reaches a point above the FOUP opener 1 as a result of conveyance by the unillustrated conveying apparatus, signal checking is performed between the conveying apparatus and the FOUP opener 1.

On the basis of the checked signal, there are read data stored in a storage section 61 and regarding the transport position of the dock plate 31 (data regarding the transport position of the dock plate 31 for each conveying apparatus, which data are stored at the time of installation of the FOUP opener 1, which will be described later).

A control means 60 drives and controls the dock-moving motor 312 of the dock-moving mechanism 30 on the basis of the read data so as o move the dock plate 31 to the transfer position.

The dock-moving motor 312, the mechanism for moving the dock plate 31 to the transport position by means of rotation of the dock-moving motor 312 and via the ball screw mechanism, and the control means 60 constitute means for changing the stop position of the dock plate 31. This stop position changing means can change the stop position of the dock plate 31 to a desired position in the X-axis direction.

After the dock plate 31 has moved to the transport position, the conveying apparatus lowers the FOUP 10 so as to transfer the FOUP 10 to the FOUP opener 1.

The above is the operation of transferring the FOUP 10 between the conveying apparatus and the dock plate 31 in Embodiment 1.

### EMBODIMENT 2

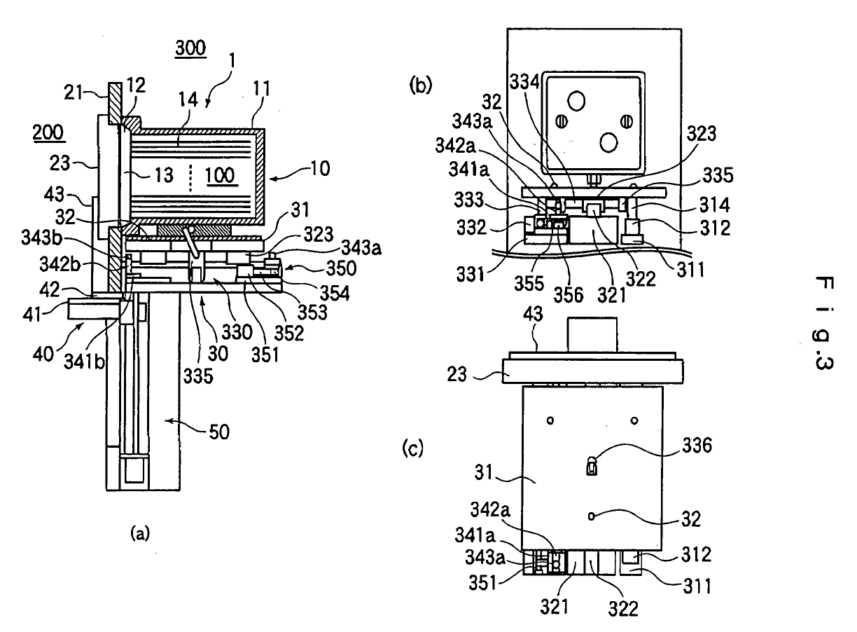

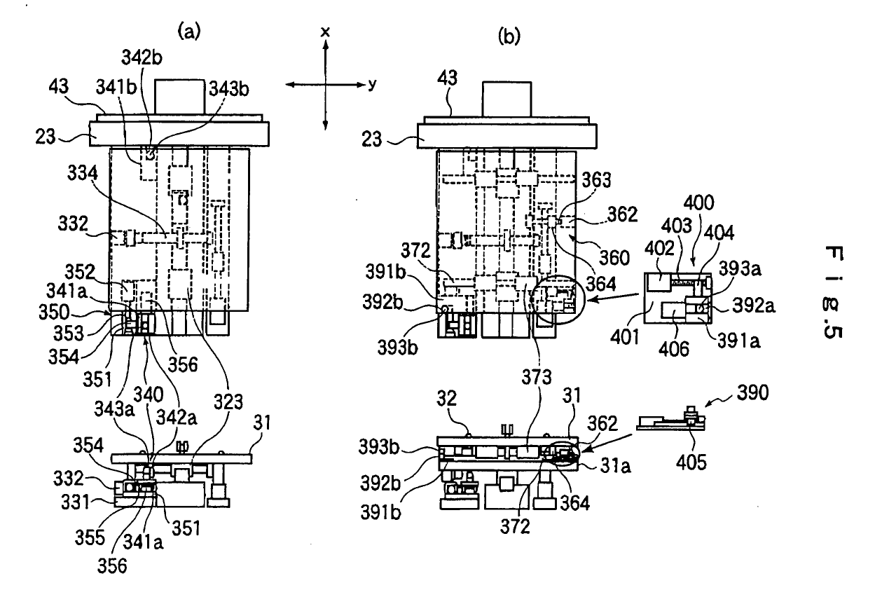

Next, a second embodiment (Embodiment 2) of the present invention will be described in detail with reference to FIGS. 3 and 5 (a) . Here, only the structure of a detection-sensor moving mechanism 350 will be described. Since other structures; i.e., the basic structure of the FOUP opener 1, the structure of the FOUP 10, the structure of the lock mechanism 330, and the structure of the dock-moving mechanism 30, are identical with those of Embodiment 1, their descriptions will not be repeated.

In Embodiment 2, the detection-sensor moving mechanism 350, which moves the detection sensor 343a for detecting the position of the dock plate 31 to a desired position, is configured as follows.

As shown in FIGS. 3 and 5(a), a base 351 of the detection-sensor moving mechanism 350 is fixedly mounted to the vicinity of an end portion of the upper surface of the base 331, and a rail 356 is fixedly mounted to the upper surface of the base 351. A slide member 355 is fitted onto the rail 356 to be slidable along the rail 356. A fixing member 341a is fixedly mounted to the slide member 355, and a transmission member 354 is connected to a portion of the fixing member 341a.

Further, the mounting member 342a of the detection sensor 343a is fixedly mounted to the upper surface of the fixing member 341a. The detection sensor 343a is mounted to the mounting member 342a, so that the position of the detection sensor 343a can be adjusted slightly through sliding of the sliding member 355 on the rail 356.

The transmission member 354 is mounted to the fixing member 341a such that the transmission member 354 is in screw engagement with a ball screw 353, and moves horizontally along the screw when the detection sensor drive motor 352 is activated and the ball screw 353 rotates as a result of rotation of the output shaft of the detection sensor drive motor 352.

Meanwhile, at the FOUP-door detaching position (work position), the detection sensor 343b for checking whether or not the dock plate 31 has reached the work position is fixedly mounted to the mounting member 342b. This mounting member 342b is fixedly mounted to the fixing member 341b, which is fixedly mounted to an upper portion of an end portion of the base 331. The detection sensor 343b defines a reference position of the dock plate 31 in the X-axis direction.

Modification of Embodiment 2

Next, a modification of Embodiment 2 will be described with reference to FIGS. 5(a) and 5(b). FIGS. 5(a) and 5(b) differ in the structure of the dock-moving mechanism. The dock-moving mechanism 30 shown in FIG. 5(b) is configured to move the dock plate 31 in two directions; i.e., the X-axis and Y-axis directions. This structure differs from that shown in FIG. 5(a). Since the remaining components and mechanisms are the same as those shown in FIG. 5(a), they are dented by the same names and reference numerals, and their detailed description will not be repeated.

In the dock-moving mechanism 30 shown in FIG. 5(a), the dock plate 31 is mounted to a mounting surface of the slide member 323. In contrast, in the dock-moving mechanism 30 shown in FIG. 5(b), in place of the dock plate 31, an auxiliary plate 31a is mounted to the mounting surface of the slide member 323 so as to move the dock plate 31 in two directions; i.e., the X-axis and Y-axis directions. Two generally parallel rails 372 are fixedly mounted on the upper surface of the auxiliary plate 31a at a predetermined interval such that the rails 372 extend generally parallel to the plane of the port door 23. Two slide members 373 are attached to each rail 372 to be slidable along the rail 372. The dock plate 31 is fixedly mounted to the upper surfaces of the slide members 373.

A dock plate moving mechanism 360 is provided between the two rails 372 so as to move the dock plate 31 in the Y-axis direction. The dock plate moving mechanism 360 includes a dock-moving motor 362 serving as a drive source; a ball screw 363 for transmitting rotational torque output from the output shaft of the dock-moving motor 362; and a transmission member 364 which is in screw engagement with the thread groove of the ball screw 363 and slides horizontally upon rotation of the ball screw 363. The transmission member 364 is fixedly mounted to a portion of the lower surface of the dock plate 31. This structure enables the dock plate 31 to move in the Y-axis direction.

Further, a detection-sensor moving mechanism 400 is provided so as to move to a desired position a detection sensor 393a for restricting the movement of the dock plate 31 in the Y-axis direction and detecting the positioning position in the Y-axis direction. This detection-sensor moving mechanism 400 is configured as follows.

As shown in FIG. 5(b), a base 401 of the detection-sensor moving mechanism 400 is fixedly mounted to an end portion of the upper surface of the auxiliary plate 31a, and a rail 406 is fixedly mounted to the upper surface of the base 401. A slide member 405 is fitted onto the rail 406 to be slidable along the rail 406. A fixing member 391a is fixedly mounted to the slide member 405, and a transmission member 404 is connected to a portion of the fixing member 391a.

Further, a mounting member 392a of the detection sensor 393a is fixedly mounted to the upper surface of the fixing member 391a. The detection sensor 393a is mounted to the mounting member 392a, so that the position of the detection sensor 393a can be adjusted slightly through sliding of the sliding member 405 on the rail 406. This detection sensor 393a detects the FOUP receiving position during the Y-axis movement of the dock plate 31.

The transmission member 404 is mounted to the fixing member 391a such that the transmission member 404 is in screw engagement with a ball screw 403, and moves horizontally along the screw when the detection sensor drive motor 402 is activated and the ball screw 403 rotates as a result of rotation of the output shaft of the detection sensor drive motor 402.

Meanwhile, the detection sensor 393b for detecting the reference position of the dock plate 31 in the Y-axis direction is mounted to a mounting member 392b. This mounting member 392b is mounted to the fixing member 391b, which is mounted to an end portion of an upper surface of the auxiliary plate 31a. The mounting member 392b is fixedly mounted to an end portion of the auxiliary plate 31a so as to enable the detection sensor 393b to detect the reference position of the dock plate 31 during movement in the Y-axis direction.

FOUP-Receiving Operation of Embodiment 2

Next, operation steps in Embodiment 2, from receiving the FOUP 10 to moving the FOUP 10 to a work position, will be described with reference to FIGS. 6(a) to 6(d), which were referenced in relation to Embodiment 1.

When the FOUP 10 is not placed on the dock plate 31, the dock plate 31 stands by at the FOUP transfer position (position apart from the port plate 21). At this time, the detection sensors 343a and 343b are used as a means for checking the stop position of the dock plate 31 so as to determine the FOUP transfer position of the dock plate 31 (FIG. 6(a)).

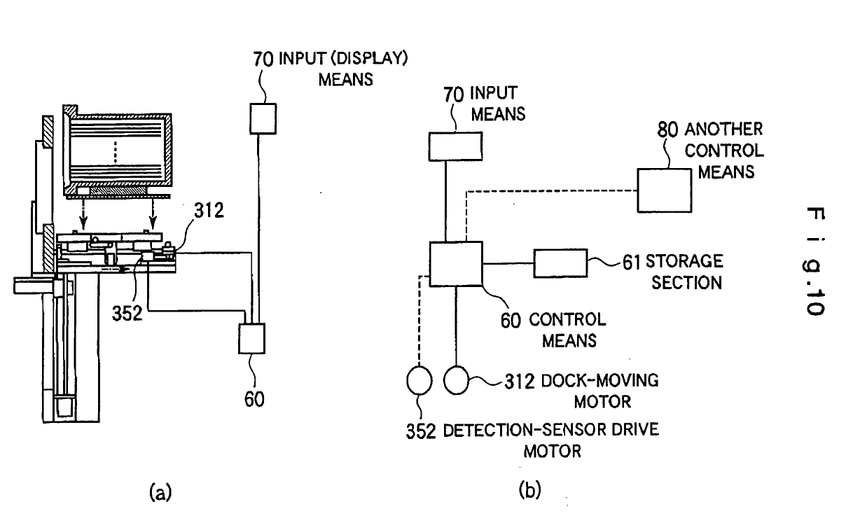

Next, the FOUP 10 is conveyed onto the FOUP opener 1 by means of an unillustrated conveying apparatus, and the conveying apparatus stops generally above the dock plate 31. After stoppage, signal communication is performed between the conveying apparatus and the FOUP opener 1, and the FOUP 10 is transferred onto the dock plate 31 such that the positioning grooves 15 of the FOUP 10 are aligned with the positioning pins 32 provided on the dock plate 31 (FIG. 6(b)). In Embodiment 1, the dock plate 31 is moved to the receiving position on the basis of data stored in the storage section 61 (see FIG. 9). In contrast, in Embodiment 2, the dock plate 31 is moved to the receiving position, after the detection-sensor moving mechanism 350 moves the detection-checking mechanism 340 to the transfer position on the basis of data stored in the storage section 61 (see FIG. 10).

The FOUP 10 placed on the dock plate 31 is temporarily fixed on the dock plate 31 by means of lock action of the lock mechanism 330 (FIG. 6(c)).

After being locked on the dock plate 31, the FOUP 10 is moved to a work position (position close to the port plate 21) through operation of the dock moving mechanism 30.

When the FOUP 10 reaches the work position, the FOUP door 13 is unlocked by means of the FOUP-door opening-closing mechanism incorporated in the port door 23, and is removed from the FOUP frame 11. After that, the FOUP door 13 is held on the port door 23, which is then horizontally moved to a predetermined position by the port-door advancing-retracting mechanism 40, and is lowered to a predetermined position by the port-door elevating mechanism 50.

The above is the general operation during a period in which the FOUP 10 is conveyed by an unillustrated conveying apparatus and is received by the FOUP opener 1, and the FOUP door 13 is removed. Notably, the operation from attachment of the FOUP door 13 to transfer of the FOUP 10 to the conveying apparatus is performed in an order that is reverse that of the receiving operation.

Alignment Operation of Embodiment 2

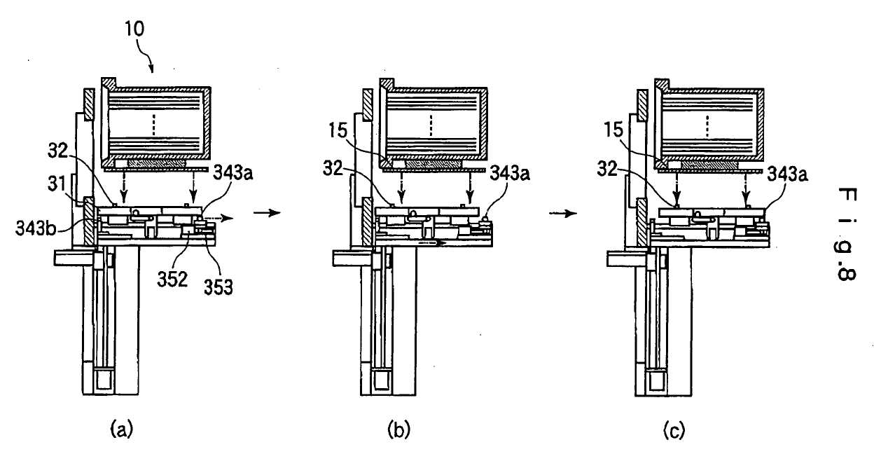

Next, operation of establishing alignment between the positioning grooves 15 of the FOUP 10 and the positioning pins 32 of the dock plate 31 in Embodiment 2 will be described with reference to FIGS. 8(a) to (c) and FIG. 10.

When the FOUP 10 is not placed on the dock plate 31, the dock plate 31 stands by at the FOUP transfer position (position apart from the port plate 21). At this time, the detection sensors 343a and 343b check the FOUP transfer position and the work position of the dock plate 31.

Next, the FOUP 10 is conveyed to the FOUP opener 1 by the unillustrated conveying apparatus, and the conveying apparatus stops generally above the dock plate 31. After stoppage, signal communication is performed between the conveying apparatus and the FOUP opener 1, and position data of the dock plate 31 matching the conveyance apparatus which performs transfer (data regarding the transport position of the dock plate 31 for each conveying apparatus, which data are stored at the time of installation of the FOUP opener 1, which will be described later) are read from the storage section 61 (FIG. 8(a)).

Subsequently, the control means 60 drives and controls the detection-sensor drive motor 352 of the detection-sensor moving mechanism 350 on the basis of the read data so as to move the detection sensor 343a to a predetermined position corresponding to the transfer position of the dock plate 31 (FIG. 8(b)).

The detection-sensor drive motor 352, the mechanism for moving the detection sensor 343a to a predetermined position by means of rotation of the detection-sensor drive motor 352 and via the ball screw mechanism, and the control means 60 constitute means for changing the installation position of the detection sensor 343a. This installation position changing means can change the installation position of the detection sensor 343a to a desired position in the X-axis direction.

After the detection sensor 343a has moved to the predetermined position, the dock plate 31 is moved to the transfer position of the FOUP 10 by the dock plate moving mechanism 30, and is detected by the detection sensor 343a, whereby the dock plate 31 stops. After that, the FOUP 10 is placed on the dock plate 31.

The above is the general operation in a period in which the FOUP 10 is conveyed to a position above the FOUP opener 1 by the unillustrated conveying apparatus, and the dock plate 31 is moved to the transfer position of the FOUP 10 through operation of the detection-sensor moving mechanism 350.

Installation of FOUP Opener

Next, a conventional installation method and an installation method of the present invention, which are used for installation of the FOUP opener 1, will be described with reference to FIGS. 11 and 12.

Conventional Installation Method (FIG. 11)

When a conventional FOUP opener (in which the dock plate has a fixed stop position) is installed at an interface portion of an unillustrated process apparatus, the FOUP opener is provisionally disposed at a position specified by the standard, and a conveying apparatus for conveying FOUPs is caused to stand by above the FOUP opener (step 500).

Next, the position of the FOUP opener installed in step 500 or that of the conveying apparatus is adjusted (step 501).

Subsequently, a holding portion of the conveying apparatus which holds a FOUP is manually and gradually moved to a position where the positions of the positioning grooves of the FOUP and the positioning pins of the dock plate can be checked. Further, the dock plate is moved to a position where the positions of the positioning grooves of the FOUP held by the holding portion of the conveying apparatus and the positioning pins of the dock plate can be checked (step 502).

Next, a check is made as to whether or not each of the positioning grooves of the moved FOUP is located within a range in which the positioning groove is generally aligned with the corresponding positioning pin of the dock plate (whether or not the FOUP transfer position is within a predetermined range) (step 503).

When it is determined in step 503 that the FOUP transfer position is outside the predetermined range, the install position of the FOUP opener or the stop position of the conveying apparatus is re-set (step 506).

After that, the FOUP opener and the conveying apparatus are manually moved again, and the position of each positioning groove of the FOUP and the position of the corresponding positioning pin of the dock plate are manually checked (step 507). After that, steps 503, 506, and 507 are repeated until the deviation between the two positions falls within the predetermined range; i.e., until the FOUP transfer position is moved to the predetermined range.

Next, when the FOUP transfer position is moved to the predetermined range, the FOUP transfer position for transfer between another conveying apparatus and the FOUP opener is checked (step 504). Then, the procedure of steps 501, 502, 503, 504, 506, and 507 is repeated. When the positions of FOUP transfer between a plurality of conveying apparatuses and the FOUP opener have been checked, the installation of the FOUP opener is completed (step 505).

Installation Method of the Present Invention (FIG. 12)

Next, a method of installing the FOUP opener 1 according to the present invention will be described with reference to FIG. 12.

When the FOUP opener 1 of the present invention (in which the stop position of the dock plate 31 is variable) is installed at an interface portion of an unillustrated process apparatus, the FOUP opener 1 is provisionally disposed at a position specified by the standard, and a conveying apparatus for conveying the FOUP 10 is caused to stand by above the FOUP opener 1 (step 600).

Next, the position of the FOUP opener 1 installed in step 600 or that of the conveying apparatus is adjusted (step 601).

Subsequently, a holding portion of the conveying apparatus which holds the FOUP 10 is manually and gradually moved to a position where the positions of the positioning grooves 15 of the FOUP 10 and the positioning pins 32 of the dock plate 31 can be checked. Further, the dock plate 31 is moved to a position where the positions of the positioning grooves 15 and the positioning pins 32 can be checked (step 602).

Next, a check is made as to whether or not each of the positioning grooves 15 of the moved FOUP 10 is located within a range in which the positioning groove is generally aligned with the corresponding positioning pin 32 of the dock plate 31 (whether or not the FOUP transfer position is within a predetermined range) (step 603).

When it is determined in step 603 that the FOUP transfer position is outside the predetermined range (the positioning grooves 15 and the positioning pins 32 are not in general alignment), the dock plate 31 is manually moved again for adjustment such that the positioning grooves 15 of the FOUP 10 are generally aligned with the positioning pins 32 of the dock plate 31 (step 606).

Next, after the FOUP transfer position is moved to the predetermined range (the positioning grooves 15 are generally aligned with the positioning pins 32), as shown in FIG. 10, position data of the dock plate 31 are input to the control means 60 by use of input means 70. After that, the position data are stored in the storage section 61 (steps 610 and 611). At this time, through management using identification numbers which enable identification of each of the conveying apparatuses, the position data of the dock plate 31 can be stored for each conveying apparatus.

Next, the position of FOUP transfer between another conveying apparatus and the FOUP opener is checked (step 604). Then, the procedure of steps 602, 603, 606, 610, and 611 is repeated. When the positions of FOUP transfer between a plurality of conveying apparatuses and the FOUP opener 1 have been checked, the installation of the FOUP opener 1 is completed (step 605).

Modification of the Detection-Sensor Moving Mechanisms of Embodiment 2

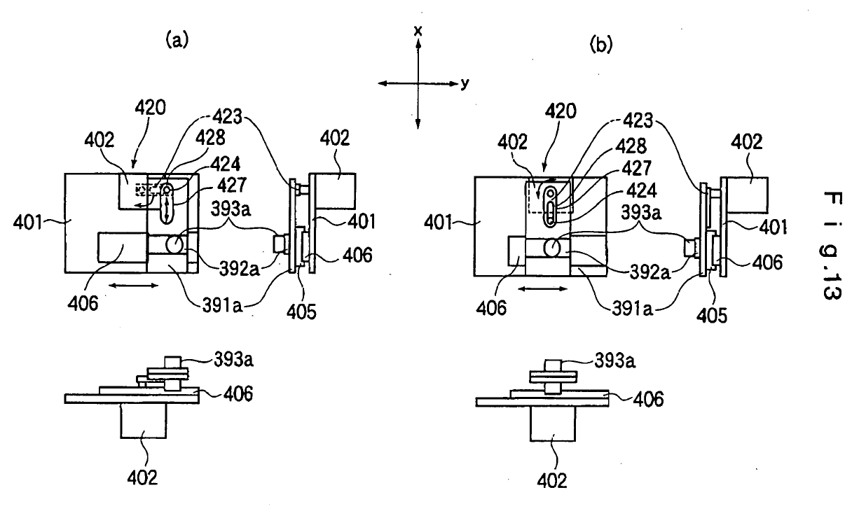

Next, a modification of the detection-sensor moving mechanisms 350 and 400 in Embodiment 2 will be described. In the detection-sensor moving mechanisms 350 and 400 in Embodiment 2, the ball screws 353 and 403 are used to move the detection sensor 343a and 393a. However, in place of these ball screws, cam mechanisms may be used. FIG. 13 shows an example (detection-sensor moving mechanism 420) of a detection-sensor moving mechanism which is identical with the detection-sensor moving mechanism 400 shown in FIG. 5(b) except that a cam mechanism is used in place of the ball screw 403.

The detection-sensor moving mechanism 420 shown in FIG. 13 is configured as follows.

In FIG. 13(a), one end of an arm-shaped transmission member 423 is fixed to the output shaft of the detection-sensor drive motor 402, and a cam follower 424 is rotatably attached to the other end of the transmission member 423. This cam follower 424 slides within a cam groove 427 formed in one half of the fixing member 391a while rolling, when the transmission member 423 is rotated as a result of rotation of the output shaft of the detection-sensor drive motor 402. Simultaneously, the fixing member 391a receives from the cam follower 424 a pressing force in the direction along the rail. 406, and moves along the rail 406 together with the slide member 405. This configuration enables positional adjustment of the detection sensor 393a along the rail 406 (Y-axis direction). FIG. 13(b) shows an adjusted position which the detection sensor 393a occupies when the transmission member 423 is rotated to a position where the longitudinal direction of the transmission member 423 becomes perpendicular to the rail 406.

The fixing member 391a corresponds to a combination of the fixing member 391a and the transmission member 404 of the detection-sensor moving mechanism 400 shown in FIG. 5(b). The mounting position of the cam follower 424 on the transmission member 423 can be adjusted by properly moving the cam follower 424 within an adjustment groove 428 formed in the transmission member 423, and fixing the cam follower 424. Thus, the maximum position adjustment amount of the detection sensor 393a can be changed.

Since the remaining components are the same as those of the detection-sensor moving mechanism 400 shown in FIG. 5(b), they are denoted by the same names and reference numerals, and their detailed description will not be repeated.

### EMBODIMENT 3

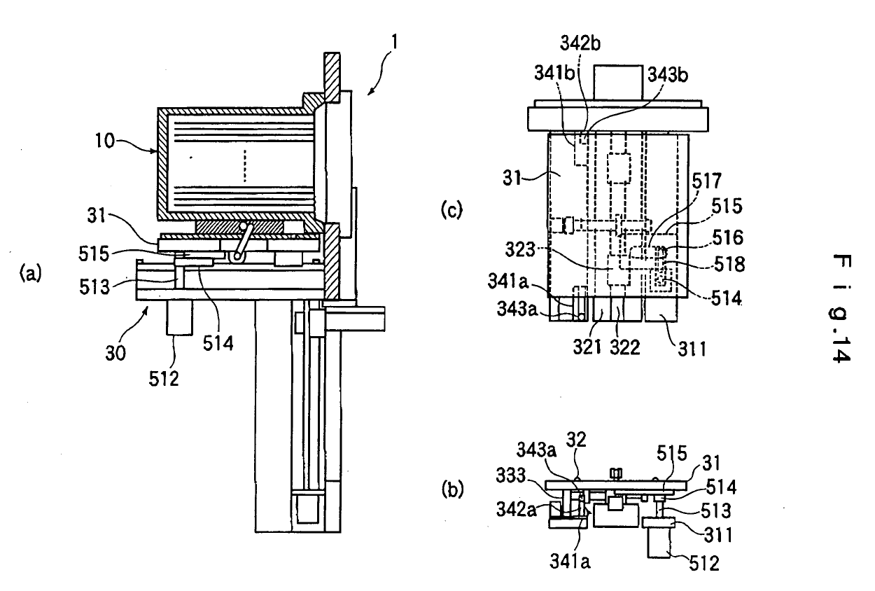

Next, an embodiment in which the cam mechanism shown in FIG. 13 is used as a dock plate moving mechanism will be described in detail as Embodiment 3 with reference to FIG. 14.

Embodiment 3 differs from Embodiment 1 (see FIG. 2) in that, in place of the ball screw, a cam mechanism is used in a moving mechanism portion of the dock-moving mechanism 30. Since the remaining components are the same, they are denoted by the same names and reference numerals, and their detailed description will not be repeated.

In the dock-moving mechanism 30 of FIG. 14, a dock-moving motor 512 is fixedly mounted on the lower surface of the base 311, and an unillustrated cut hole is formed in the base 311 so as to enable the output shaft 513 of the dock-moving motor 512 to vertically penetrate the base 311. One end of an arm-shaped transmission member 514 is fixed to the output shaft 513, and a cam follower 516 is rotatably attached to the other end of the transmission member 514. This cam follower 516 slides within a cam groove 517 formed in a portion of a fixing member 515 while rolling, when the transmission member 514 is rotated as a result of rotation of the output shaft 513 of the dock-moving motor 512. Simultaneously, the fixing member 515 receives from the cam follower 516 a pressing force in the direction along the rail 322, and moves along the rail 322 together with the slide member 323. This configuration enables movement of the dock plate 31 along the rail 322.

The mounting position of the cam follower 516 on the transmission member 514 can be adjusted by properly moving the cam follower 516 within an adjustment groove 518 formed in the transmission member 514, and fixing the cam follower 516. Thus, the maximum position adjustment amount of the dock plate 31 can be changed.

Since the remaining components are the same as those of the dock-moving mechanism 30 shown in FIG. 2, they are denoted by the same names and reference numerals, and their detailed description will not be repeated.

Modifications of Control Means and Motors

Control of the dock-moving-motors 312 and 512, the detection-sensor drive motor 352, etc. performed by the control means 60 may be performed as follows. Servomotors are used for these motors, and control of these motor is performed by means of numerical control. This enables automatic, accurate control.

### INDUSTRIAL APPLICABILITY

As described above, the container opening-closing apparatus and the container-placement-position adjustment method therefor according to the present invention enable easy, quick, and reliable alignment between a conveying apparatus and a FOUP opener at the time of installation of the FOUP opener. Further, a FOUP can be placed on the placement section of the FOUP opener without fail, and thus, the present invention has a significant degree of industrial applicability.

1. A container opening-closing apparatus comprising at least:
a dock plate for supporting and positioning a container capable of accommodating a plurality of semiconductor wafers oriented horizontally and arranged at predetermined intervals;
a dock-moving mechanism for moving the dock plate between a container transfer position and a work position where a container door is attached and detached;
a port door including an attaching-detaching mechanism for attaching and detaching the container door and a holding mechanism for holding the container door;
a port-door advancing-retracting mechanism for horizontally moving the port door;
a port-door elevating mechanism for vertically moving the port door with the container door held thereby so as to store the container door; and
a port plate having an opening closed by the port door,
wherein the dock-moving mechanism includes stop position changing means for changing a stop position of the dock plate to a desired position.

2. A container opening-closing apparatus according to claim 1, wherein the stop position changing means includes control means for changing the stop position of the dock plate to a desired position by means of numerical control.

3. A container opening-closing apparatus according to claim 1, wherein when a moving direction along which the dock plate moves for removal of the container door is defined as an X-axis direction and a direction perpendicular to the X-axis direction is defined as a Y-axis direction, the stop position of the dock plate can be changed to a desired position in the X-axis direction.

4. A container opening-closing apparatus according to claim 1, wherein when a moving direction along which the dock plate moves for removal of the container door is defined as an X-axis direction and a direction perpendicular to the X-axis direction is defined as a Y-axis direction, the stop position of the dock plate can be changed to desired positions in the X-axis and Y-axis directions.

5. A container opening-closing apparatus comprising at least:
a dock plate for supporting and positioning a container capable of accommodating a plurality of semiconductor wafers oriented horizontally and arranged at predetermined intervals;
a dock-moving mechanism for moving the dock plate between a container transfer position and a work position where a container door is attached and detached;
a port door including an attaching-detaching mechanism for attaching and detaching the container door and a holding mechanism for holding the container door;
a port-door advancing-retracting mechanism for horizontally moving the port door;
a port-door elevating mechanism for vertically moving the port door with the container door held thereby so as to store the container door; and
a port plate having an opening closed by the port door,
wherein the dock-moving mechanism includes stop position checking means for checking a stop position of the dock plate, and installation position changing means for changing the installation position of the stop position checking means to a desired position.

6. A container opening-closing apparatus according to claim 5, wherein the installation position changing means includes control means for changing the installation position of the stop position checking means to a desired position by means of numerical control.

7. A container opening-closing apparatus according to claim 5, wherein when a moving direction along which the dock plate moves for removal of the container door is defined as an X-axis direction and a direction perpendicular to the X-axis direction is defined as a Y-axis direction, the installation position of the stop position checking means can be changed to a desired position in the X-axis direction.

8. A container opening-closing apparatus according to claim 5, wherein when a moving direction along which the dock plate moves for removal of the container door is defined as an X-axis direction and a direction perpendicular to the X-axis direction is defined as a Y-axis direction, the installation position of the stop position checking means can be changed to desired positions in the X-axis and Y-axis directions.

9. A container-placement-position adjustment method for a container opening-closing apparatus comprising at least:
container placement means for supporting and positioning a container capable of accommodating a plurality of semiconductor wafers oriented horizontally and arranged at predetermined intervals;
moving means for moving the container placement means between a container transfer position and a work position where a container door is attached and detached; and
attaching-detaching means for attaching and detaching the container door of the container placed on the container placement means moved to the work position by the moving means,
wherein the moving means can change a stop position of the container placement means to a desired position.

10. A container-placement-position adjustment method for a container opening-closing apparatus according to claim 9, wherein the moving means changes the stop position of the container placement means to a desired position by means of numerical control.

11. A container-placement-position adjustment method for a container opening-closing apparatus comprising at least:
container placement means for supporting and positioning a container capable of accommodating a plurality of semiconductor wafers oriented horizontally and arranged at predetermined intervals;
moving means for moving the container placement means between a container transfer position and a work position where a container door is attached and detached; and
attaching-detaching means for attaching and detaching the container door of the container placed on the container placement means moved to the work position by the moving means,
wherein the moving means can change to a desired position a position for checking a stop position of the container placement means.

12. A container-placement-position adjustment method for a container opening-closing apparatus according to claim 11, wherein the moving means changes the position for checking the stop position of the container placement means to a desired position by means of numerical control.

13. A container opening-closing apparatus according to claim 2, wherein when a moving direction along which the dock plate moves for removal of the container door is defined as an X-axis direction and a direction perpendicular to the X-axis direction is defined as a Y-axis direction, the stop position of the dock plate can be changed to a desired position in the X-axis direction.

14. A container opening-closing apparatus according to claim 2, wherein when a moving direction along which the dock plate moves for removal of the container door is defined as an X-axis direction and a direction perpendicular to the X-axis direction is defined as a Y-axis direction, the stop position of the dock plate can be changed to desired positions in the X-axis and Y-axis directions.

15. A container opening-closing apparatus according to claim 6, wherein when a moving direction along which the dock plate moves for removal of the container door is defined as an X-axis direction and a direction perpendicular to the X-axis direction is defined as a Y-axis direction, the installation position of the stop position checking means can be changed to a desired position in the X-axis direction.

16. A container opening-closing apparatus according to claim 6, wherein when a moving direction along which the dock plate moves for removal of the container door is defined as an X-axis direction and a direction perpendicular to the X-axis direction is defined as a Y-axis direction, the installation position of the stop position checking means can be changed to desired positions in the X-axis and Y-axis directions.
